(19) United States
(12) Patent Application Publication
(10) Pub. No.: US 2024/0321113 A1
(43) Pub. Date: Sep. 26, 2024

(54) TRAVEL PATH MONITORING SYSTEMS AND METHODS

(71) Applicant: HONEYWELL INTERNATIONAL INC., Charlotte, NC (US)

(72) Inventors: Thea Feyereisen, Minneapolis, MN (US); Ryan Milmoe, Phoenix, AZ (US)

(73) Assignee: HONEYWELL INTERNATIONAL INC., Charlotte, NC (US)

(21) Appl. No.: 18/188,669

(22) Filed: Mar. 23, 2023

(51) Int. Cl. G08G 5/00; G08G 5/04

(52) U.S. Cl. CPC G08G 5/0021; G08G 5/0039; G08G 5/006; G08G 5/0091; G08G 5/045

(57) ABSTRACT

Systems and methods are provided for travel path monitoring during operation of a mobile platform. The system may include a database configured to store a preprogramed travel plan, a navigation system configured to monitor the travel plan and a geographical position of the mobile platform, a controller operably coupled to the navigation system and the database and configured to, by a processor: detect a deviation of a travel path of the mobile platform from the travel plan, monitor a travel parameter in response to detecting the deviation, and generate a first notification configured to alert a crew of the mobile platform of the deviation in response to the travel parameter exceeding a travel parameter threshold.

### TECHNICAL FIELD

The present invention generally relates to aircraft systems, and more particularly relates to systems and methods for monitoring travel paths of mobile platforms, such as aircraft, and providing notifications relating to deviations from travel plans.

### BACKGROUND

Various systems are available to promote flight crew awareness on manned aircraft with the intension of improving overall safety. Exemplary systems include flight anti-collision systems such as the Traffic Collision Avoidance System (TCAC) and anti-terrain-collision systems such as the Terrain Awareness Warning System (TAWS). In addition, modern manned aircraft may include various systems specifically intended to address flight crew distraction concerns. For example, some aircraft include a camera-based pilot state monitoring system intended to detect pilot related issues. As another example, some aircraft include bus inactivity monitoring systems intended to detect a lack of activity on a communication bus of an electronic component of the aircraft. While these additional systems may promote overall safety, they do not provide assistance or awareness relating to specific tasks.

Hence, there is a need for systems and methods capable of provide assistance or awareness relating to specific tasks during operation of an aircraft. Furthermore, other desirable features and characteristics of the present invention will become apparent from the subsequent detailed description and the appended claims, taken in conjunction with the accompanying drawings and the foregoing technical field and background.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A system is provided for travel path monitoring during operation of a mobile platform. In certain embodiments, the system includes a database configured to store a preprogramed travel plan, a navigation system configured to monitor the travel plan and a geographical position of the mobile platform, a controller operably coupled to the navigation system and the database and configured to, by a processor: detect a deviation of a travel path of the mobile platform from the travel plan, monitor a travel parameter in response to detecting the deviation, and generate a first notification configured to alert a crew of the mobile platform of the deviation in response to the travel parameter exceeding a travel parameter threshold.

A method is provided for travel path monitoring during operation of a mobile platform. In certain embodiments, the method includes storing, in a database, a travel plan for the mobile platform, detecting, with a processor onboard the mobile platform, a deviation of a travel path of the mobile platform from the travel plan, monitoring, with the processor, a travel parameter in response to detecting the deviation, and generating, with the processor, a first notification configured to alert a crew of the mobile platform of the deviation in response to the travel parameter exceeding a travel parameter threshold.

Furthermore, other desirable features and characteristics of the system and method will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 is a block diagram representing an exemplary aircraft having a flight path monitoring system in accordance with an embodiment;

FIG. 2 is a dataflow diagram illustrating operation of the flight path monitoring system of FIG. 1 in accordance with an embodiment;

FIG. 3 is a flowchart illustrating an exemplary method for flight path monitoring during operation of a mobile platform in accordance with an embodiment; and

FIGS. 4-6 schematically represent an exemplary flight of the aircraft of FIG. 1 and illustrates various nonlimiting aspects of operation thereof in accordance with an embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Systems and methods disclosed herein provide for monitoring a travel path during operation of a mobile platform. For convenience, the mobile platform will be discussed herein in reference to an aircraft. It should be noted that the term aircraft, as utilized herein, may include any manned or unmanned object capable of flight. Examples of aircraft may include, but are not limited to, fixed-wing aerial vehicles (e.g., propeller-powered or jet powered), rotary-wing aerial vehicles (e.g., helicopters), manned aircraft, unmanned aircraft (e.g., unmanned aerial vehicles, or UAVs), delivery drones, etc. For convenience, the systems and methods will be described in reference to a manned airplane; however, the systems and methods are not limited to such application and may be applicable to any mobile platform that uses a predetermined travel plan and which may deviate from such travel plan. For example, the system and methods may be used with various watercraft such as certain ships, boats, and the like.

The systems may be configured to promote flight crew awareness regarding deviations from preprogrammed flight plans. The systems may monitor a flight path of an aircraft to detect deviation therefrom or receive notice from one or more other systems (e.g., a navigation system) that the aircraft has diverted from the flight plan. Deviations from the flight plan may include deviations from a vertical flight plan and/or from a lateral flight plan. The deviations may be intended (e.g., change of heading) or unintended deviations (e.g., system error, pilot error, weather related, etc.). The systems may then monitor one or more flight parameters while the aircraft remains diverted from the flight plan, and provide prompts, reminders, notifications, and/or alarms (collectively referred to as notifications herein) based on such monitoring. Various flight parameters may be used for determining whether and when to generate the notifications. In various embodiments, the monitored flight parameter(s) may include a time lapse since the aircraft deviated from the flight plan. For example, the system may generate a notification after the aircraft has been off the flight plan for a predetermined period of time (e.g., 15 minutes). In various embodiments, the monitored flight parameter(s) may include a distance traveled by the aircraft since the aircraft deviated from the flight plan. For example, the system may generate a notification after the aircraft has traveled a predetermined distance (e.g., 75 miles). In various embodiments, the monitored flight parameter(s) may include the shortest distance between the aircraft 10 and the flight plan. For example, the system may generate a notification after the aircraft has reached a predetermined distance from the flight plan (e.g., 30 miles). In various embodiments, the monitored flight parameter(s) may include a distance between the aircraft 10 and an obstacle (e.g., a storm cell/cloud, a restricted airspace, another aircraft, etc.). For example, the system may generate a notification after the aircraft has reached a predetermined distance (e.g., 10 miles) from a center of, a hazardous portion of, or an edge of a storm cell.

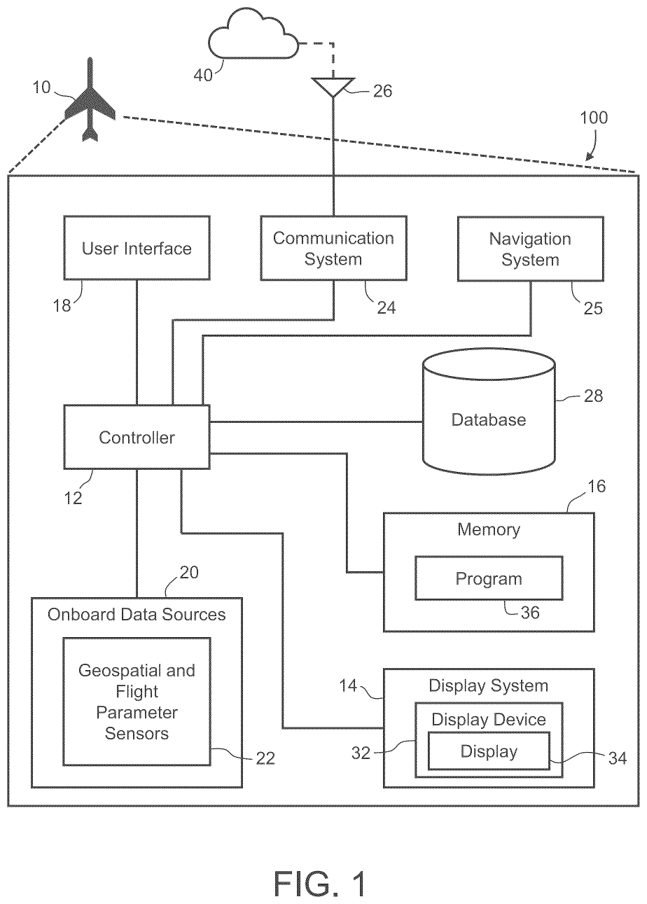

Referring now to FIG. 1, an aircraft 10, such as an airplane, and certain systems thereof are illustrated in accordance with an exemplary and non-limiting embodiment of the present disclosure. A flight path monitoring system 100 may be utilized onboard the aircraft 10 as described herein. As schematically depicted in FIG. 1, the system 100 includes and/or is functionally coupled to the following components or subsystems, each of which may assume the form of a single device or multiple interconnected devices, including, but not limited to, a controller 12 operationally coupled to: at least one display device 32, which may optionally be part of a larger on-board display system 14; computer-readable storage media or memory 16; an optional user interface 18, and onboard data sources 20 including, for example, an array of flight system status and geospatial sensors 22. The system 100 may be separate from or integrated within a flight management system (FMS) and/or a flight control system (FCS). The system 100 may also contain a communication system 24 including an antenna 26, which may wirelessly transmit data to and receive data from various sources external to the system 100. The system 100 may include a navigation system 25 configured to manage and monitor the navigation of the aircraft 10, including a flight plan and the position of the aircraft 10.

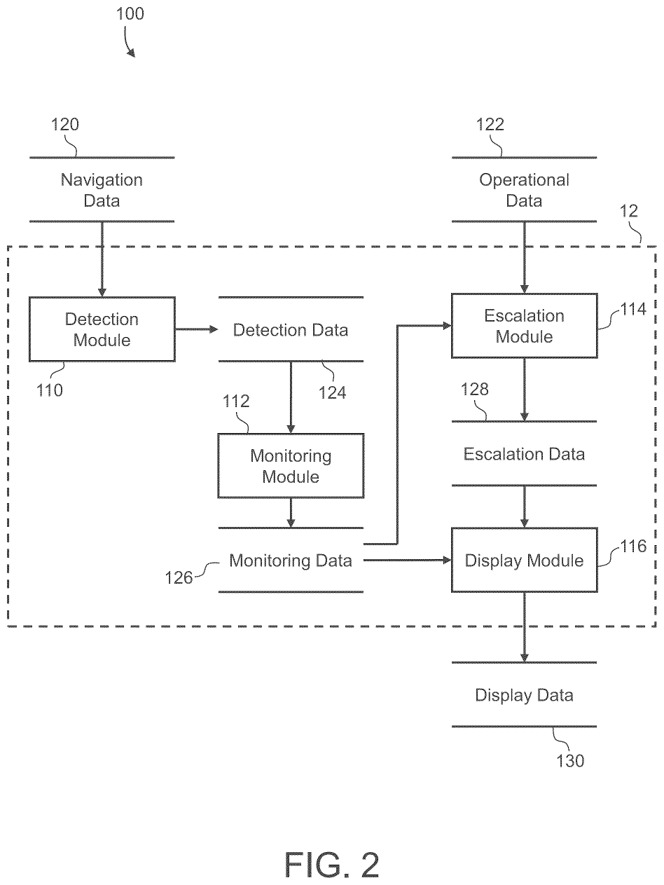

Although schematically illustrated in FIG. 2 as a single unit, the individual elements and components of the system 100 can be implemented in a distributed manner utilizing any practical number of physically distinct and operatively interconnected pieces of hardware or equipment. When the system 100 is utilized as described herein, the various components of the system 100 will typically all be located onboard the aircraft 10.

The term “controller,” as appearing herein, broadly encompasses those components utilized to carry-out or otherwise support the processing functionalities of the system 100. Accordingly, the controller 12 can encompass or may be associated with any number of individual processors, flight control computers, navigational equipment pieces, computer-readable memories (including or in addition to the memory 16), power supplies, storage devices, interface cards, and other standardized components.

In various embodiments, the controller 12 includes at least one processor, a communication bus, and a computer readable storage device or media. The processor performs the computation and control functions of the controller 12. The processor can be any custom made or commercially available processor, a central processing unit (CPU), a graphics processing unit (GPU), an auxiliary processor among several processors associated with the controller 12, a semiconductor-based microprocessor (in the form of a microchip or chip set), any combination thereof, or generally any device for executing instructions. The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the processor is powered down. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 12. The bus serves to transmit programs, data, status and other information or signals between the various components of the aircraft 10. The bus can be any suitable physical or logical means of connecting computer systems and components. This includes, but is not limited to, direct hard-wired connections, fiber optics, infrared, and wireless bus technologies.

The instructions may include one or more separate programs, each of which comprises an ordered listing of executable instructions for implementing logical functions. The instructions, when executed by the processor, receive and process signals from the sensors 22, perform logic, calculations, methods and/or algorithms, and generate data based on the logic, calculations, methods, and/or algorithms. Although only one controller 12 is shown in FIG. 1, embodiments of the aircraft 10 can include any number of controllers 12 that communicate over any suitable communication medium or a combination of communication mediums and that cooperate to process the sensor signals, perform logic, calculations, methods, and/or algorithms, and generate data. In various embodiments, the controller 12 includes or cooperates with at least one firmware and software program (generally, computer-readable instructions that embody an algorithm) for carrying-out the various process tasks, calculations, and control/display functions described herein. During operation, the controller 12 may be programmed with and execute at least one firmware or software program, for example, a program 36, that embodies one or more algorithms, to thereby perform the various process steps, tasks, calculations, and control/display functions described herein.

The controller 12 may exchange data with one or more external sources 40 to support operation of the system 100 in various embodiments. In this case, bidirectional wireless data exchange may occur via the communication system 24 over a communications network, such as a public or private network implemented in accordance with Transmission Control Protocol/Internet Protocol architectures or other conventional protocol standards. Encryption and mutual authentication techniques may be applied, as appropriate, to ensure data security.

In various embodiments, the communication system 24 is configured to support instantaneous (i.e., real time or current) communications between on-board systems, the controller 12, and the one or more external source(s) 40. The communication system 24 may incorporate one or more transmitters, receivers, and the supporting communications hardware and software required for components of the system 100 to communicate as described herein. In various embodiments, the communication system 24 may have additional communications not directly relied upon herein, such as bidirectional pilot-to-ATC (air traffic control) communications via a datalink, and any other suitable radio communication system that supports communications between the aircraft 10 and various external source(s).

The memory 16 can encompass any number and type of storage media suitable for storing computer-readable code or instructions, such as the program 36, as well as other data generally supporting the operation of the system 100. As can be appreciated, the memory 16 may be part of the controller 12, separate from the controller 12, or part of the controller 12 and part of a separate system. The memory 16 can be any suitable type of storage apparatus, including various different types of direct access storage and/or other memory devices.

A source of information suitable for operation of other the aircraft 10 and/or displaying various environmental renderings during operation of the aircraft 10 may be part of the system 100. In certain embodiments, the source is one or more databases 28 employed to receive and store map data, which may be updated on a periodic or iterative basis to ensure data timeliness. In various embodiments, the map data may include various terrain and manmade object locations and elevations and may be stored in the memory 16 or in the one or more databases 28, and referenced by the program 36. In various embodiments, these databases 28 may be available online and accessible remotely by a suitable wireless communication system, such as the communication system 24.

The sensors 22 supplies various types of data and/or measurements to the controller 12. In various embodiments, the sensors 22 supplies, without limitation, one or more of: inertial reference system measurements providing a location, Flight Path Angle (FPA) measurements, airspeed data, groundspeed data, vertical speed data, vertical acceleration data, altitude data, attitude data including pitch data and roll measurements, yaw data, data related to ownship weight, time/date information, heading information, data related to atmospheric conditions, flight path data, flight track data, radar altitude data, geometric altitude data, wind speed and direction data for the aircraft 10 and/or for other aircraft. Further, in certain embodiments of the system 100, the controller 12, and the other components of the system 100 may be included within or cooperate with any number and type of systems commonly deployed onboard aircraft including, for example, an FMS, an Attitude Heading Reference System (AHRS), an Instrument Landing System (ILS), and/or an Inertial Reference System (IRS).

The navigation system 25 can provide navigation data associated with the aircraft's current position and flight direction (e.g., heading, course, track, etc.) to the controller 12. As such, the navigation system 25 can include, for example, an inertial navigation system, a satellite navigation system (e.g., Global Positioning System) receiver, VLF/OMEGA, Loran C, VOR/DME, DME/DME, IRS, aircraft attitude sensors, or the navigation information can come from a flight management system. The navigation data provided to the controller 12 can also include information about the aircraft's airspeed, ground speed, altitude (e.g., relative to sea level), pitch, and other important flight information. In any event, for this example embodiment, the navigation system 25 can include any suitable position and direction determination devices that are capable of providing the controller 12 with at least an aircraft's current position (e.g., in latitudinal and longitudinal form), the real-time direction (heading, course, track, etc.) of the aircraft in its flight path, and other important flight information (e.g., airspeed, altitude, pitch, attitude, etc.).

With continued reference to FIG. 1, the display device 32 can include any number and type of image generating devices on which one or more avionic displays 34 may be produced. In various embodiments, the display device 32 may be affixed to the static structure of the aircraft 10 cockpit as, for example, a Head Down Display (HDD) or Head Up Display (HUD) unit. Alternatively, the display device 32 may assume the form of a movable display device (e.g., a pilot-worn display device) or a portable display device, such as an Electronic Flight Bag (EFB), a laptop, or a tablet computer carried into the aircraft 10 cockpit by a pilot.

At least one avionic display 34 is generated on display device 32 during operation of the system 100. The term “avionic display” as used herein is synonymous with the terms “aircraft-related display” and “cockpit display” and encompasses displays generated in textual, graphical, cartographical, and other formats. The system 100 can generate various types of lateral and vertical avionic displays 34 on which symbology, text annunciations, and other graphics pertaining to flight planning are presented for a pilot to view. The display device 32 is configured to continuously render at least one avionic display 34 showing a terrain environment at a current location of the aircraft 10. The avionic display 34 generated and controlled by the system 100 can include alphanumerical input displays of the type commonly presented on the screens of multi-function control and display units (MCDUs), as well as Control Display Units (CDUs) generally. Specifically, certain embodiments of the avionic displays 34 include one or more two dimensional (2D) avionic displays, such as a horizontal (i.e., lateral) navigation display or vertical navigation display; and/or on one or more three dimensional (3D) avionic displays, such as a Primary Flight Display (PFD) or an exocentric 3D avionic display.

In various embodiments, a human-machine interface, such a touch screen display, is implemented as an integration of the user interface 18 and the display device 32. Via various display and graphics systems processes, the controller 12 may command and control the touch screen display generating a variety of graphical user interface (GUI) objects or elements, for example, buttons, sliders, and the like, which are used to prompt a user to interact with the human-machine interface to provide user input, and to activate respective functions and provide user feedback, responsive to received user input at the GUI element.

With reference to FIG. 2 and with continued reference to FIG. 1, a dataflow diagram illustrates elements of the system 100 of FIG. 1 in accordance with various embodiments. As can be appreciated, various embodiments of the system 100 according to the present disclosure may include any number of modules embedded within the controller 12 which may be combined and/or further partitioned to similarly implement systems and methods described herein. Furthermore, inputs to the system 100 may be received from other control modules (not shown) associated with the aircraft 10, and/or determined/modeled by other sub-modules (not shown) within the controller 12. Furthermore, the inputs might also be subjected to preprocessing, such as sub-sampling, noise-reduction, normalization, feature-extraction, missing data reduction, and the like. In various embodiments, the system 100 includes a detection module 110, a monitoring module 112, an escalation module 114, and a display module 116.

In various embodiments, the detection module 110 receives as input navigation data 120 generated by the navigation system 25. The navigation data 120 includes various data indicating a flight plan for the aircraft 10, a position of the aircraft 10, and various other information relating to the navigation of the aircraft 10. In various embodiments, the navigation data 120 includes an indication that the aircraft 10 has been intentionally diverted from the flight plan, for example, by changing a heading of the aircraft 10. The detection module 110 performs an analysis of the navigation data 120 and determines whether the aircraft 10 has diverged from the flight plan. The detection module 110 generates detection data 124 that includes various data indicating that the aircraft 10 has diverged from the flight plan.

In various embodiments, the monitoring module 112 receives as input the detection data 124 generated by the detection module 110. The monitoring module 112 monitors a flight parameter of the aircraft 10 and compares the flight parameter to a flight parameter threshold. As nonlimiting examples, the flight parameter may be a time lapse since the deviation, a distance traveled since the deviation, a distance of the aircraft 10 from the flight plan, or a distance of the aircraft 10 from an obstacle (e.g., a storm cell, a restricted airspace, another aircraft, etc.). If the flight parameter exceeds the flight parameter threshold, the monitoring module 112 generates monitoring data 126 that includes various data indicating that a first notification should be generated and provided to the flight crew.

In various embodiments, the escalation module 114 receives as input the monitoring data 126 generated by the monitoring module 112. The escalation module 114 monitors for a response to the first notification. In various embodiments, the response may include one or more actions, such as but not limited to a change in the heading of the aircraft 10 such that the flight path returns to the flight plan, or an acknowledgement by the flight crew of the notification. In response to the notification, the escalation module 114 also begins a notification timer and compares the notification timer to a notification timer threshold. If the escalation module 114 detects an appropriate response to the first notification, the escalation module 114 may stop the notification timer. If the response is an acknowledgement from the flight crew, the escalation module 114 may restart or extend the notification timer for a predetermined period (e.g., a snooze feature) rather than entirely stopping the timer and the monitoring. If the notification timer exceeds the notification timer threshold prior to detection of a response to the first notification, the escalation module 114 may determine that escalation is necessary, and generate escalation data 128 that includes various data indicating that an additional notification should be generated and provided to the flight crew. In various embodiments, the escalation module 114 may repeat this process for each new notification generated, with an option to escalate at each iteration (e.g., increase volume of an audible alarm, flash a visual light or graphic, contact additional members of the flight crew, etc.).

In various embodiments, the display module 116 receives as input the monitoring data 126 generated by the monitoring module 112 and, optionally, the escalation data 128 generated by the escalation module 114. The display module 116 generates display data 130 that includes instructions for the display system 14 such that the first notification and/or one or more additional notifications are generated and, for example, displayed on the display 34 of the display device 32.

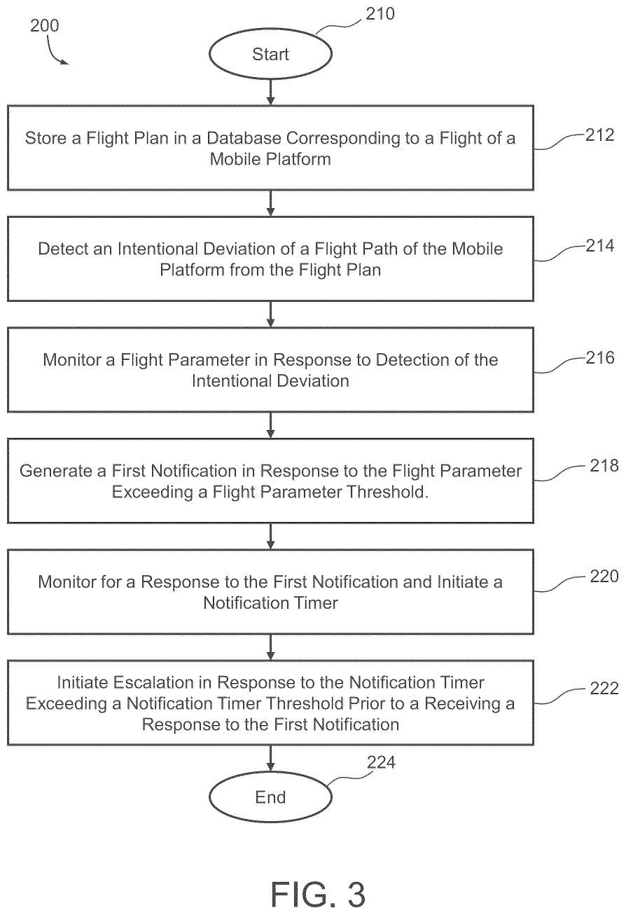

The systems disclosed herein, including the system 100 of the aircraft 10, provide for methods of flight path monitoring during operation of a mobile platform. For example, FIG. 3 is a flow chart illustrating an exemplary method 200 for monitoring a flight path of the aircraft 10. The method 200 may begin at 210. At 212, the method 200 may include storing a flight plan corresponding to a particular flight for the aircraft 10 in a database (e.g., the database 28). At 214, the method 200 may include detecting with a processor onboard the aircraft 10 a deviation of a flight path of the aircraft 10 from the flight plan. In various embodiments, an intentional deviation from the flight plan may be detected based on a change in the heading of the aircraft 10 or initiation of a heading mode of a flight management system.

At 216, the method 200 may include monitoring, with the processor, a flight parameter in response to detecting the intentional deviation. As nonlimiting examples, the flight parameter may be a time lapse since the deviation, a travel distance since the deviation, a distance of the aircraft 10 from the flight plan, or a distance of the aircraft 10 from an obstacle (e.g., a storm cell, a restricted airspace, another aircraft, etc.). At 218, the method 200 may include generating, with the processor, a first notification configured to alert a flight crew of the aircraft 10 of the deviation in response to the flight parameter exceeding a flight parameter threshold.

At 220, the method 200 may include monitoring for one or more actions in response to the first notification. In various embodiments, the one or more actions may include a change in the heading of the aircraft 10 such that the flight path returns to the flight plan, or an acknowledgement by the flight crew of the notification. At 222, the method 200 may include generating initiating an escalation procedure in response to a failure to detect any one of the one or more actions within predetermined conditions, such as a notification timer exceeding a notification timer threshold (e.g., 15 minutes). The escalation procedure may include, for example, modification to the first notification (e.g., flashing), generation of a second notification configured to alert the flight crew, generation of an audible alarm, etc. The method 200 may end at 222.

In various embodiments, the escalation procedure may include contacting systems and/or personnel external to the aircraft 10 (e.g., air traffic control). In various embodiments, the escalation procedure may include modifying and/or changing an operational mode of the aircraft 10. For example, in some embodiments, the escalation procedure may include transferring control of the aircraft 10 to an autonomous or semi-autonomous control system of the aircraft 10 or to a remote controller exterior to the aircraft 10.

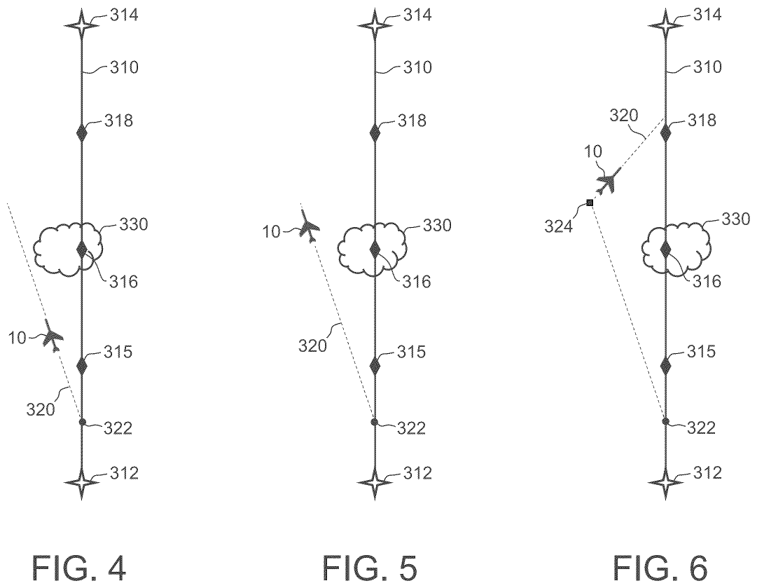

FIGS. 4-6 presents portions of an exemplary flight of the aircraft 10 to illustrate various nonlimiting aspects of the systems and methods disclosed herein. The flight includes a preprogrammed flight plan 310 extending from a departure location 312 to a destination location 314. Waypoints 315, 316, and 318 are provided along the flight plan 310 between the departure location 312 and the destination location 314. Although the flight plan 310 in this example is a lateral flight plan, the systems and methods are not limited to this application and may be used in relation to deviations from vertical flight plans.

The flight plan 310 intersects a storm 330 that may pose a hazard to the aircraft 10. Therefore, as represented in FIG. 4, the aircraft 10 has been diverted from the flight plan 310 at a location 322 such that the aircraft 10 is traveling along a flight path 320 having a heading that is intended to pass the storm 330. In various embodiments, the system 100 may detect and/or be notified of the deviation from the flight plan 310 at the location 322 and begin monitoring one or more flight parameters. For this example, the flight parameter is a distance from the storm 330. In FIG. 5, the aircraft 10 has reached a predetermined distance from the storm 330 (e.g., as measured to a center of the storm 330, an edge of the storm 330, a hazardous portion of the storm 330, etc.) and therefore generates a first notification to the flight crew. For example, the first notification may be a visual message asking whether the flight crew desires to return to the flight plan 310.

Upon generating the first notification, the system 100 begins monitoring for a response. If no response was detected prior to expiration of, for example, a notification timer, the system 100 could perform escalation procedures. However, in this example, the aircraft 10 has a change of heading at a location 324 such that the flight path 320 is directed toward the flight plan 310 as represented in FIG. 6. As such, the system 100 detects the change of heading at the location 324, and ceases the monitoring and notification activities.

The systems and methods disclosed herein provide various benefits over certain existing systems and methods. For example, the systems are capable of providing flight crews with timely information relating to the flight path and flight plan relationship. This may include prompts to return to flight plans, notifications that hazards have been avoided, etc. This functionality may be beneficial in various situations. As examples, the systems may reduce the likelihood of error or inefficiency due to flight crew distraction, and reduce the workload for flight crew.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A system for travel path monitoring during operation of a mobile platform, the system comprising:
a database configured to store a preprogramed travel plan;
a navigation system configured to monitor the travel plan and a geographical position of the mobile platform;
a controller operably coupled to the navigation system and the database and configured to, by a processor:
detect a deviation of a travel path of the mobile platform from the travel plan;
monitor a travel parameter in response to detecting the deviation; and
generate a first notification configured to alert a crew of the mobile platform of the deviation in response to the travel parameter exceeding a travel parameter threshold.

2. The system of claim 1, wherein the travel parameter is a time lapse since the deviation.

3. The system of claim 1, wherein the travel parameter is a distance of the mobile platform from the travel plan.

4. The system of claim 1, wherein the travel parameter is a distance of the mobile platform from an obstacle.

5. The system of claim 4, wherein the obstacle is a weather-related hazard.

6. The system of claim 1, wherein the controller is configured to, by the processor:
monitor for one or more actions in response to the first notification; and
generate a second notification configured to alert the crew of the deviation in response to a failure to detect any one of the one or more actions within predetermined conditions.

7. The system of claim 6, wherein the controller is configured to, by the processor:
initiate a first notification timer upon generating the first notification; and
cease the first notification timer upon detection of the one or more actions or upon generating the second notification,
wherein the predetermined conditions include the first notification timer exceeding a first notification threshold.

8. The system of claim 6, wherein the controller is configured to, by the processor:
monitor a distance traveled by the mobile platform upon generating the first notification,
wherein the predetermined conditions include the distance traveled exceeding a first notification threshold.

9. The system of claim 6, wherein the one or more actions include a change to a heading of the mobile platform such that the travel path intersects with the travel plan.

10. The system of claim 6, wherein the one or more actions include one or more of the crew acknowledging the first notification.

11. A method for travel path monitoring during operation of a mobile platform, the method comprising:
storing, in a database, a travel plan for the mobile platform;
detecting, with a processor onboard the mobile platform, a deviation of a travel path of the mobile platform from the travel plan;
monitoring, with the processor, a travel parameter in response to detecting the deviation; and
generating, with the processor, a first notification configured to alert a crew of the mobile platform of the deviation in response to the travel parameter exceeding a travel parameter threshold.

12. The method of claim 11, wherein the travel parameter is a time lapse since the deviation.

13. The method of claim 11, wherein the travel parameter is a distance of the mobile platform from the travel plan.

14. The method of claim 11, wherein the travel parameter is a distance of the mobile platform from an obstacle.

15. The method of claim 14, wherein the obstacle is a weather-related hazard.

16. The method of claim 11, further comprising, with the processor:
monitoring for one or more actions in response to the first notification; and
generating a second notification configured to alert the crew of the deviation in response to a failure to detect any one of the one or more actions within predetermined conditions.

17. The method of claim 16, further comprising, with the processor:
initiating a first notification timer upon generating the first notification; and
ceasing the first notification timer upon detection of the one or more actions or upon generating the second notification,
wherein the predetermined conditions include the first notification timer exceeding a first notification threshold.

18. The method of claim 16, further comprising, with the processor:
monitoring a distance traveled by the mobile platform upon generating the first notification,
wherein the predetermined conditions include the distance traveled exceeding a first notification threshold.

19. The method of claim 16, wherein the one or more actions include a change to a heading of the mobile platform such that the travel path intersects with the travel plan.

20. The method of claim 16, wherein the one or more actions include one or more of the crew acknowledging the first notification.
